(19) United States
(12) Patent Application Publication
(10) Pub. No.: US 2004/0213245 A1
(43) Pub. Date: Oct. 28, 2004

(54) Communication apparatus having shaping function

(76) Inventors: Motohiro Asai, Yokohama (JP); Shota Tsukanaka, Fujisawa (JP); Sadato Ando, Yokohama (JP); Takayuki Nishijima, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 09/785,450

(22) Filed: Feb. 20, 2001

(30) Foreign Application Priority Data
Aug. 25, 2000 (JP) 2000-260861

(51) Int. Cl. H04L 12/28

(52) U.S. Cl. 370/395.1; 370/412

(57) ABSTRACT

A communication apparatus, wherein for a connection identified by an identifier of a cell from an input port, the communication apparatus is capable of: determining transmission scheduled time of the cell according to predetermined rules; selecting a first connection when the transmission scheduled time has come; and selecting a second connection if there is no fixed-length packet to be transmitted for the first connection.

### BACKGROUND OF THE INVENTION

1. Field of the Invention

The present invention relates to a communication apparatus with a traffic shaping function in asynchronous transfer mode (hereinafter referred to as ATM).

2. Description of the Related Art

In recent years, ATM technology comes into wider use. The ATM technology provides high-speed transmission of various forms of communication data, which vary in quantity of information and in communication speed, including traffic with a high delay sensitivity (audio, image), and burst traffic (data). In a ATM network, information is exchanged in the form of a fixed-length packet that is called a ‘cell’, using the following transmission media: virtual path (hereinafter referred to as VP) that is a logical connection; and virtual channel (hereinafter referred to as VC). In addition, in the ATM network, cells, which belong to connections with service quality suitable for the various forms of communication data, share a limited transmission band (contract band).

On the other hand, when performing data communication using the ATM network, cell delay variation (hereinafter referred to as CDV) may occurs, and thereby the contract band may not be able to accommodate the quantity of data. In this case, the cell is discarded in the ATM network, resulting in a data loss. For this reason, a shaping function, which keeps a cell transmission interval (cell rate) to the ATM network constant, is required. In this connection, when performing connection setting, a user is required to declare traffic parameters, such as a cell transmission interval, and a cell delay variation tolerance (hereinafter referred to as CDVT) representing a range of CDV to be allowed, in order to make a contract regarding the transmission band. In the ATM network, usage parameter control (hereinafter referred to as UPC) function monitors as to whether or not user traffic is being transmitted according to the declared value.

As a method for realizing the shaping function described above, for example, a cell rate restriction algorithm called ‘Generic Cell Rate Algorithm (GCRA)’ is disclosed in “The ATM Forum Technical Committee Traffic Management Specification Version 4.0” (prior art 1).

In addition, in recent years, ATM private line service such as ATM megalink service, and ATM cell relay service such as super relay CR are coming into wider use. Those services efficiently integrate various forms of communication data, which vary in quantity of information and in communication speed, including audio, image, and data into one line, and transmit the various pieces of data at high speed. The ATM private line service is a service that requires making a contract of transmission band with a network for each VP, and that is suitable for high-speed communication at a short distance. The ATM cell relay service is a service that requires making a contract of transmission band with a network for each VC, and that is suitable for high-speed communication at a long distance. Such ATM private line service performs UPC for each VP, detects a VP that is in breach of contract, and then discards the cells of the VP. The ATM cell relay service performs UPC for each VC, detects a VC that is in breach of contract, and then discards the cells of the VC. Accordingly, in the whole network where the ATM private line service and the ATM cell relay service coexist, in order to transmit cells with keeping the cells from being discarded, shaping for each of VP and VC is required. However, the prior art 1 performs shaping for VP or VC. The prior art 1 does not describe a technology for performing shaping for each of VP and VC.

The technology for performing shaping for each of VP and VC is described in for example Japanese Non-examined Patent Publication No. 10-294741 (prior art 2). However, the prior art 2 does not mention that CDVT is ensured.

Moreover, as described above, ATM handles various forms of information, which vary in quantity of information and in communication speed, including audio, image, and data. Because of it, quantity of generated information is not always constant, and changes as time goes by. Accordingly, peak timing of the quantity also varies. For example, traffic of audio, image, and the like is generated in real time. On the other hand, traffic of data, and the like is generated at a burst. Therefore, if a transmission band is in advance dedicated to a connection for handling information that is not generated in real time like the traffic of data and others, the transmission band cannot be efficiently utilized when it is not used.

### SUMMARY OF THE INVENTION

An object of the present invention is to provide a communication apparatus having a shaping function, which controls a cell transmission interval so that the cell transmission interval is kept constant for each of VP and VC that are set on a transmission path.

Another object of the present invention is to provide a communication apparatus having a shaping function, which ensures CDVT.

In addition, a further object of the present invention is to provide a communication apparatus having a shaping function, which enables us to utilize a transmission band effectively.

To achieve the objects described above, a communication apparatus according to the present invention comprises: input and output port for handling a fixed-length packet; a first means for accumulating the fixed-length packet from the input port; a second means for identifying a first and a second connections by an identifier of the fixed-length packet from the input port; and a third means for controlling a time interval, during which the fixed-length packet accumulated in the first means is read, so that the time interval becomes equal to or longer than a given interval, for each of the first connection and the second connection.

The third means controls a time interval, during which the fixed-length packet accumulated in the first means is read, using a transmission interval and a delay variation value that have been predefined for the fixed-length packet.

In addition, during the time when a fixed-length packet having a first value as an identifier of the first connection is required to be transmitted to an output port, the third means enables a fixed-length packet having a second value as an identifier of the first connection to transmit to an output port according to predetermined rules.

Moreover, during the time when a fixed-length packet having a first value as an identifier of the second connection is required to be transmitted to an output port, the third means enables a fixed-length packet having a second value as an identifier of the second connection to transmit to an output port according to predetermined rules.

### BRIEF DESCRIPTION OF THE DRAWINGS

FIG. 1 is a diagram illustrating an overall configuration of a communication network to which a communication apparatus according to the present invention is applied.

FIG. 2 is a diagram illustrating a relation of connections that are set on each transmission path.

FIG. 3 is a block diagram illustrating a configuration of a communication apparatus according to the present invention.

FIG. 4 is a block diagram illustrating a configuration of a line interface unit according to the present invention.

FIG. 5 is a diagram illustrating a configuration of a status control table.

FIG. 6 is a diagram illustrating a configuration of a transmission scheduled-time reservation table.

FIG. 7 is a flowchart illustrating a cell receiving process.

FIG. 8 and FIG. 9 are flowcharts illustrating a reservation read process.

FIG. 10 is a flowchart illustrating a cell transmitting process.

FIGS. 11 through 15 are diagrams illustrating status of a status control table and status of a transmission scheduled-time reservation table at each reference time.

FIG. 16 is a diagram illustrating timing of cell sending/receiving when performing shaping in a output line interface unit.

### DESCRIPTION OF THE PREFERRED EMBODIMENTS

The following describes embodiments of a communication apparatus having a shaping function according to the present invention in detail with reference to drawings.

FIG. 1 is a diagram illustrating a configuration of an overall network.

In FIG. 1, a terminal 100 is connected to a communication apparatus 110 via a transmission path 130-1. A terminal 101 is connected to the communication apparatus 110 via a transmission path 130-n. A terminal 102 is connected to a communication apparatus 111 via a transmission path 133-1. A terminal 103 is connected to a communication apparatus 112 via a transmission path 133-n. In addition, the communication apparatus 110 is connected to the communication apparatus 111 via a transmission path 131-1, ATM network 120, and a transmission path 132-1. Moreover, the communication apparatus 110 is connected to the communication apparatus 112 via a transmission path 131-n, the ATM network 120, and a transmission path 132-n. In such conditions, VP and VC are set for each transmission path. Although the details are described later, the communication apparatuses 110 through 112 satisfy cell transmission interval and CDVT, which have been predefined for each of VP and VC, and realize a shaping function that enables us to utilize a transmission band effectively.

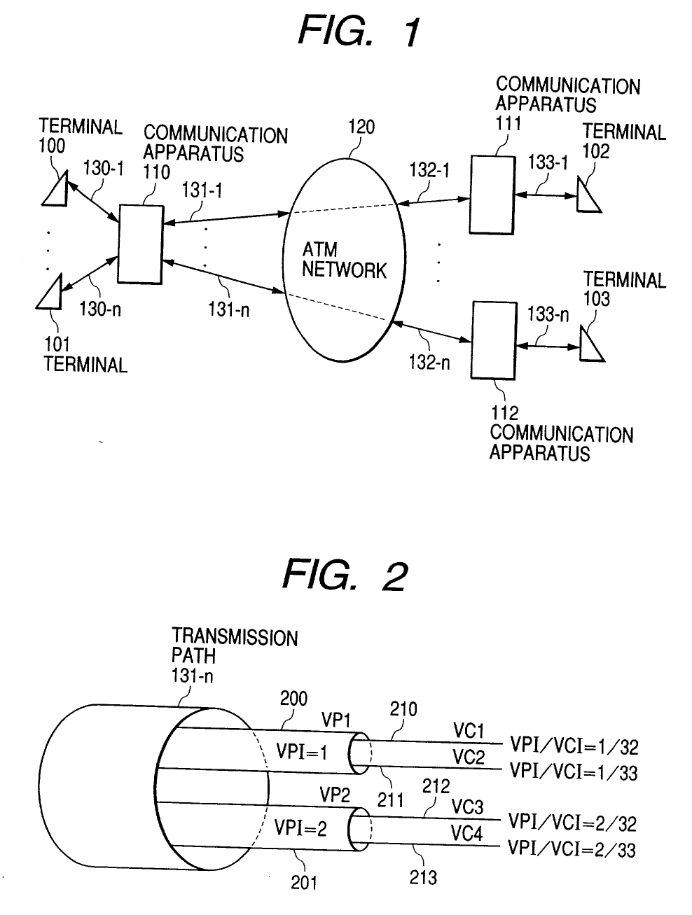

FIG. 2 is a diagram illustrating a relation of connections that are set on a transmission path (for example, 131-n). Connections that are set on transmission paths 130-1 through 130-n, 131-1 through 131-(n−1), 132-1 through 132-n, and 133-1 through 131-n also have a similar relation to this.

As shown in FIG. 2, a plurality of VPs can be set on one transmission path 131-n. Each VP comprises a plurality of VCs. In this case, VP is identified by a Virtual Path Identifier (hereinafter referred to as VPI) that is set for each link in a network. VC is identified by a Virtual Channel Identifier (hereinafter referred to as VCI) that is set for each link in a network. Hereinafter, each VC in each VP is identified using VPI/VCI. For example, VP1 and VP2 are identified by VPI=1, 2 respectively. VC1, VC2, VC3, VC4 are identified by VPI/VCI=1/32, 1/33, 2/32, 2/33 respectively.

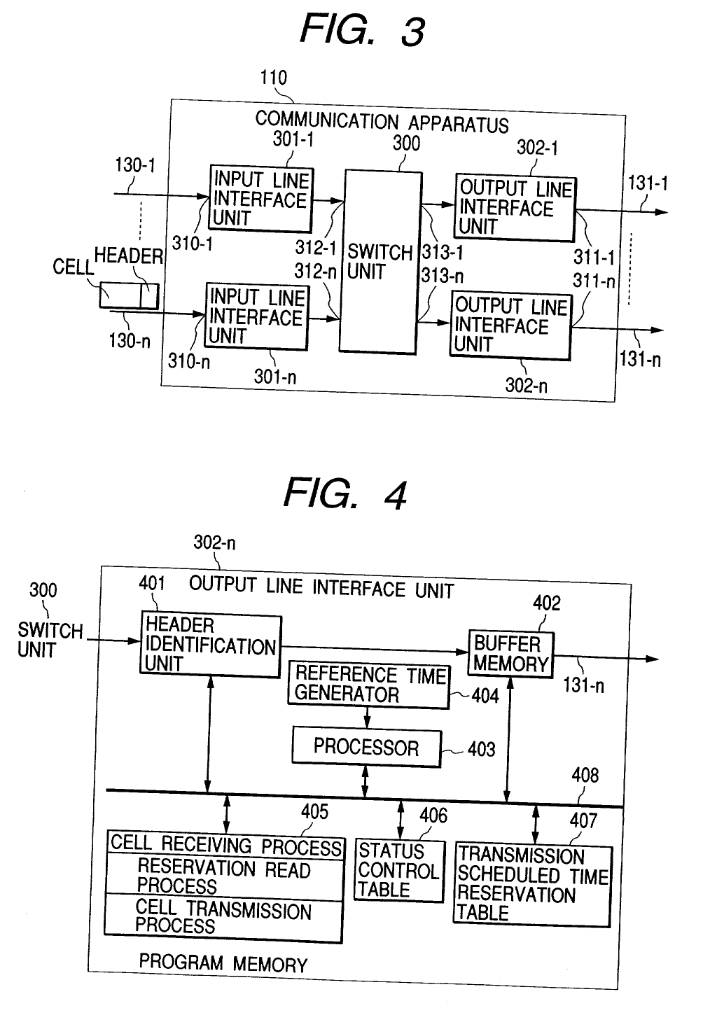

FIG. 3 is a block diagram illustrating a configuration of a communication apparatus according to the present invention (for example, the communication apparatus 110). The communication appratuses 111 and 112 also have the same configuration.

The communication apparatus 110 comprises a switch unit 300, a plurality of input line interface units 301-1 through 301-n, and a plurality of output line interface units 302-1 through 302-n. The input line interface units and the output line interface units are connected to the switch unit 300. The input line interface units 301-1 through 301-n terminate a cell coming via the transmission paths 130-1 through 130-n respectively, update contents in a header of the cell, and transmit the cell to the switch unit 300. The switch unit 300 switches a destination of the cell, which has been received from each input line interface unit, to an arbitrary output line interface unit from among the output line interface units 302-1 through 302-n according to the contents of the header. The output line interface units 302-1 through 302-n identify VP and VC according to VPI and VCI contained in the header of the cell received from the switch unit 300, and control a time interval, during which the above-mentioned cell is output, so that the interval becomes equal to or longer than a predefined interval for each of the VP and the VC. In this case, the input line interface units 301-1 through 301-n comprise ports 310-1 through 310-n that are connected to the transmission paths 130-1 through 130-n respectively. The output line interface units 302-1 through 302-n comprise ports 311-1 through 311-n that are connected to the transmission paths 131-1 through 131-n respectively. The switch unit 300 comprises ports 312-1 through 312-n that are connected to the input line interface units 301-1 through 301-n respectively. In addition, the switch unit 300 comprises ports 313-1 through 313-n that are connected to the output line interface units 302-1 through 302-n respectively.

FIG. 4 is a block diagram illustrating a configuration of the output line interface unit according to the present invention (for example, the output line interface unit 302-n). The output line interface units 302-1 through 302-(n−1) also have the same configuration.

The output line interface unit 302-n comprises a header identification unit 401, a buffer memory 402, a processor 403, a reference time generator 404, a program memory 405, a status control table 406, and a transmission scheduled-time reservation table 407. The header identification unit 401 analyzes a header of a cell from the switch unit 300, and identifies VP and VC according to VPI and VCI contained in the header. The buffer memory 402 accumulates the cell from the switch unit 300 temporarily. The processor 403 controls the following: executing a program stored in the program memory 405; writing a cell into the buffer memory 402; reading a cell from the buffer memory 402; and the like. The reference time generator 404 periodically generates reference time for determining a cell transmission interval. In the program memory 405, control programs that provide the shaping function according to the present invention, including a cell receiving process, a reservation read process, and a cell transmission process, are stored. In the status control table 406, connection control information, and traffic parameters that are used to determine cell-transmission scheduled time for each of VP and VC, are registered. By the way, the GCRA described above is used to calculate the cell-transmission scheduled time. In the transmission scheduled-time reservation table 407, each connection of VP and VC, for which the cell-transmission scheduled time is determined, is registered. In this case, at each reference time, the processor 403 checks whether or not VP and VC are registered in the transmission scheduled-time reservation table 407, by using a pointer representing current time (hereinafter referred to as ‘a pointer of current time’). In addition, the processor 403 accesses the header identification unit 401, the buffer memory 402, the program memory 405, the status control table 406, and the transmission scheduled-time reservation table 407 via a control bus 408.

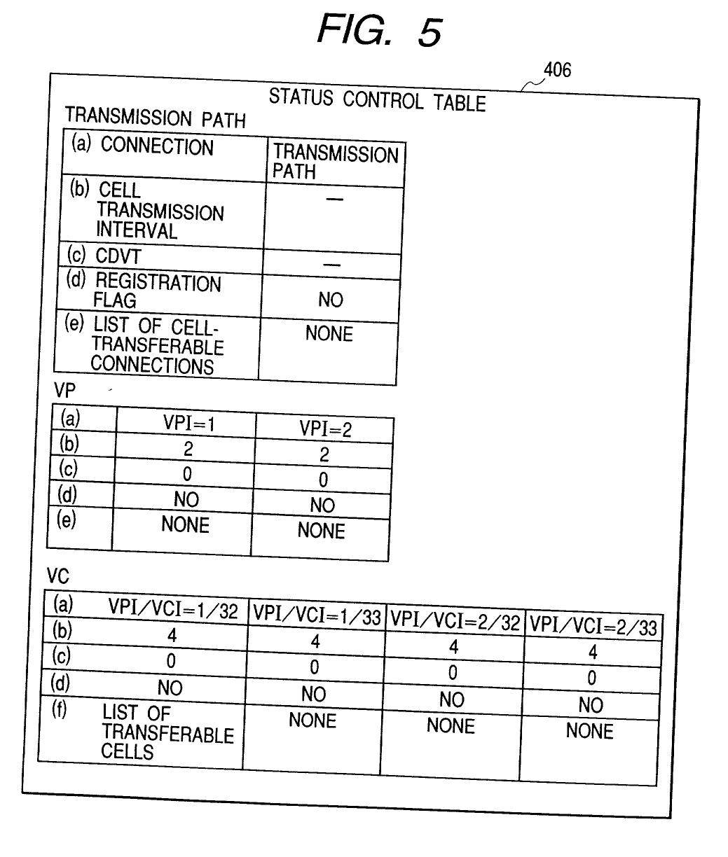

FIG. 5 is a diagram illustrating a configuration of the status control table 406.

The status control table 406 comprises a transmission path area, a VP area, and a VC area. Connection control information described below and predefined traffic parameters are registered in each of the areas. In each of the transmission path area and the VP area of the status control table 406, the following information is registered: (a) connection, (b) cell transmission interval, (c) CDVT, (d) registration flag, and (e) list of cell-transferable connections. Additionally, in the VC area of the status control table 406, the following information is registered: (a) through (d) described above, and (f) list of transferable cells. In the (a) connection, connection identification information is registered. In the (b) cell transmission interval, a cell transmission interval that is a traffic parameter specified in GCRA is registered. In the (c) CDVT, CDVT that is a traffic parameter specified in GCRA is registered. The (d) registration flag is a flag indicating that whether VP or VC has reached a cell-transmission scheduled time is being registered in the transmission scheduled-time reservation table 407. In the (e) list of cell-transferable connections, connections for which cell-transmission scheduled time has come are registered. In the (f) list of transferable cells, information for controlling transferable cells (for example, a write address for writing a cell into the buffer memory 402) is registered.

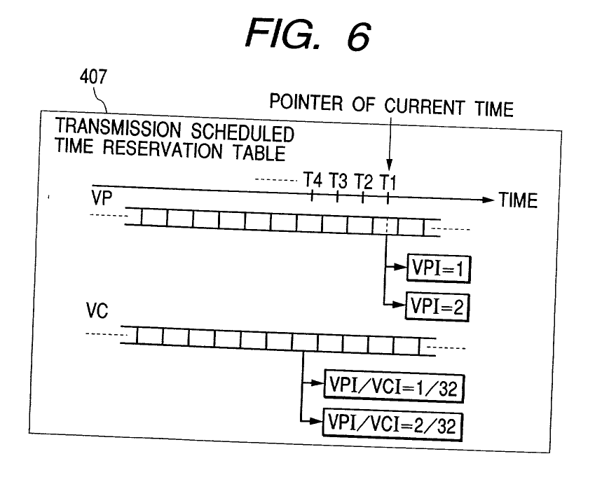

FIG. 6 is a diagram illustrating a configuration of the transmission scheduled-time reservation table 407.

The transmission scheduled-time reservation table 407 comprises a VP area and a VC area. Connections, for which cell-transmission scheduled times are determined, is registered in each area. In this case, regarding T1 for example, VP for each of VPI=1 and VPI=2 is registered. In addition, regarding T4, VC for each of VPI/VCI=1/32 and VPI/VCI=2/33 is registered.

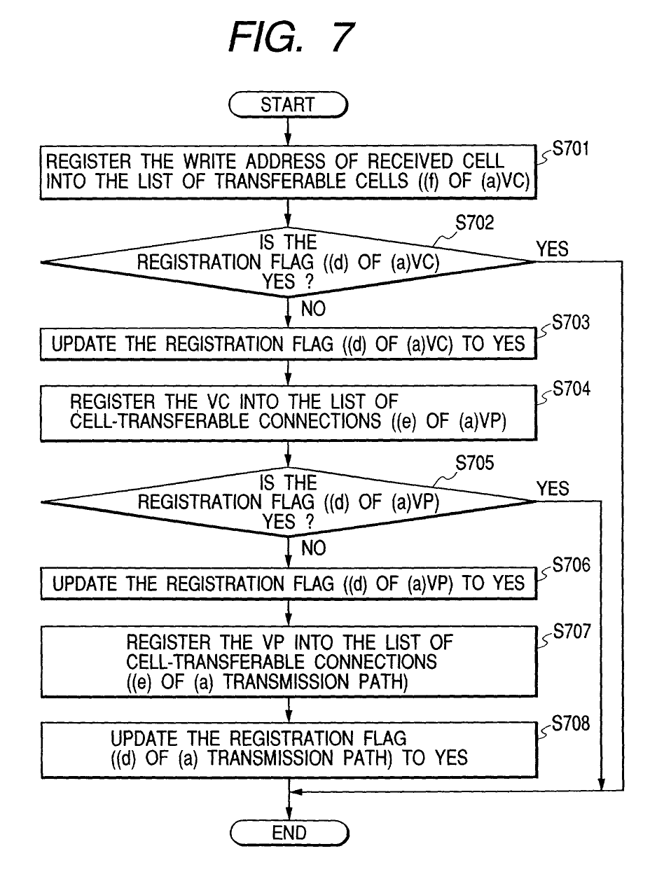

FIG. 7 is a flowchart illustrating a cell receiving process that is executed by the processor 403.

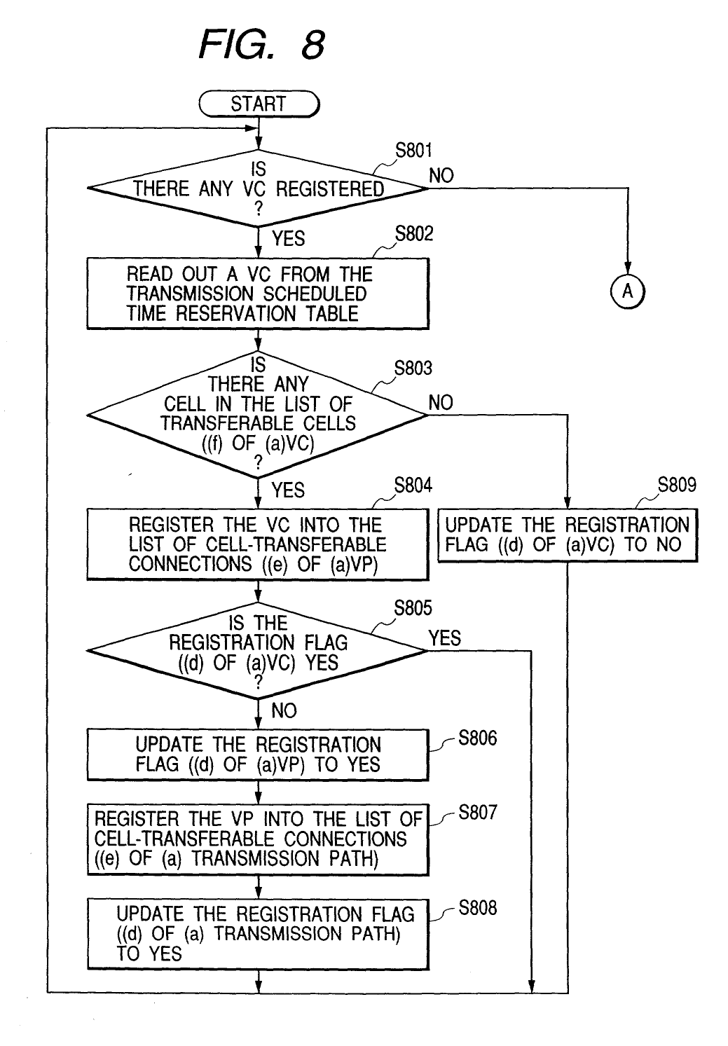

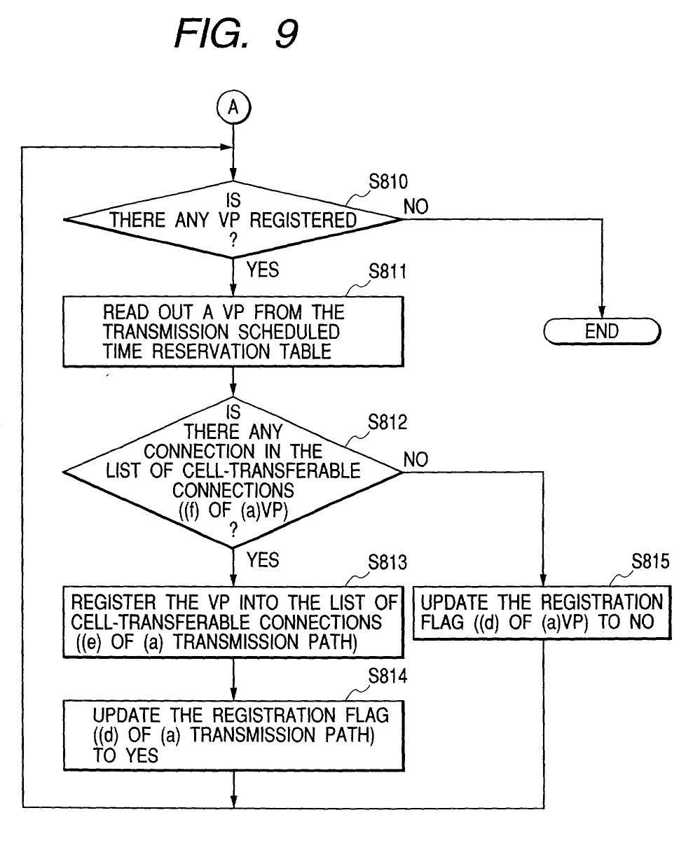

FIG. 8 and FIG. 9 are flowcharts illustrating a reservation read process that is executed by the processor 403.

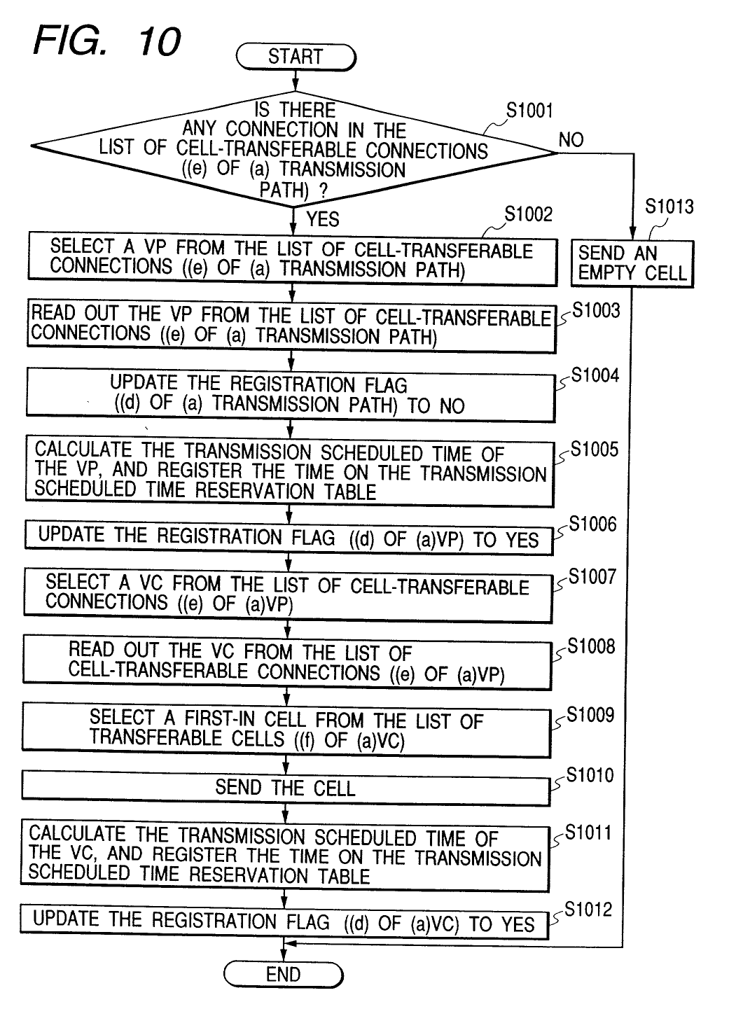

FIG. 10 is a flowchart illustrating a cell transmission process that is executed by the processor 403.

Although the details are described later, in the cell receiving process, each time a cell is received via a transmission path, for the purpose of controlling the cell as a transferable cell, the processor 403 registers a write address for writing the cell into the buffer memory 402 in the (f) list of transferable cells of the status control table 406. In addition, the processor 403 updates connection control information according to the (d) registration flag of the status control table 406.

In the reservation read process, at each reference time, the processor 403 judges whether or not there is a connection registered in the transmission scheduled-time reservation table 407, and reads out it. In addition, the processor 403 refers to the status control table 406 to judge whether or not there is a cell to be transmitted for each connection that has been read out. If there is no cell to be transmitted to a particular connection, the processor 403 selects another connection. Accordingly, because a transmission band is not dedicated to a particular connection, the transmission band can be utilized efficiently.

In the cell transmission process, at each reference time, the processor 403 refers to the status control table 406, selects a connection according to a predefined priority, and reads out a cell to be transmitted from the buffer memory 402. In this case, the priority relates to a delay of data: for example, a low priority is given to data and the like that permit fluctuations comparatively; and a high priority is given to audio, image, and the like that do not permit fluctuations. In addition, for a connection that has transmitted a cell, the processor 403 determines cell-transmission scheduled time for the next time by given traffic parameters (a cell transmission interval, a CDVT) registered in the status control table 406, and registers it in the transmission scheduled-time reservation table 407. The processes described above are executed for each of VP and VC connections.

Next, operation at the time when shaping according to the present invention is executed in the output line interface unit 302-n is described below in detail.

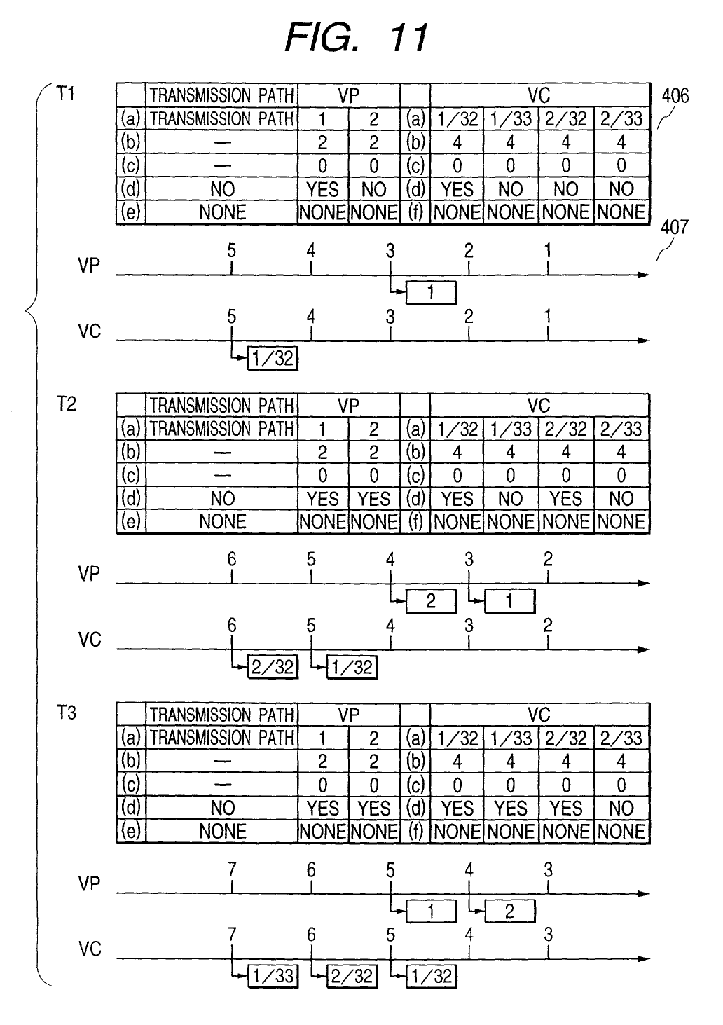

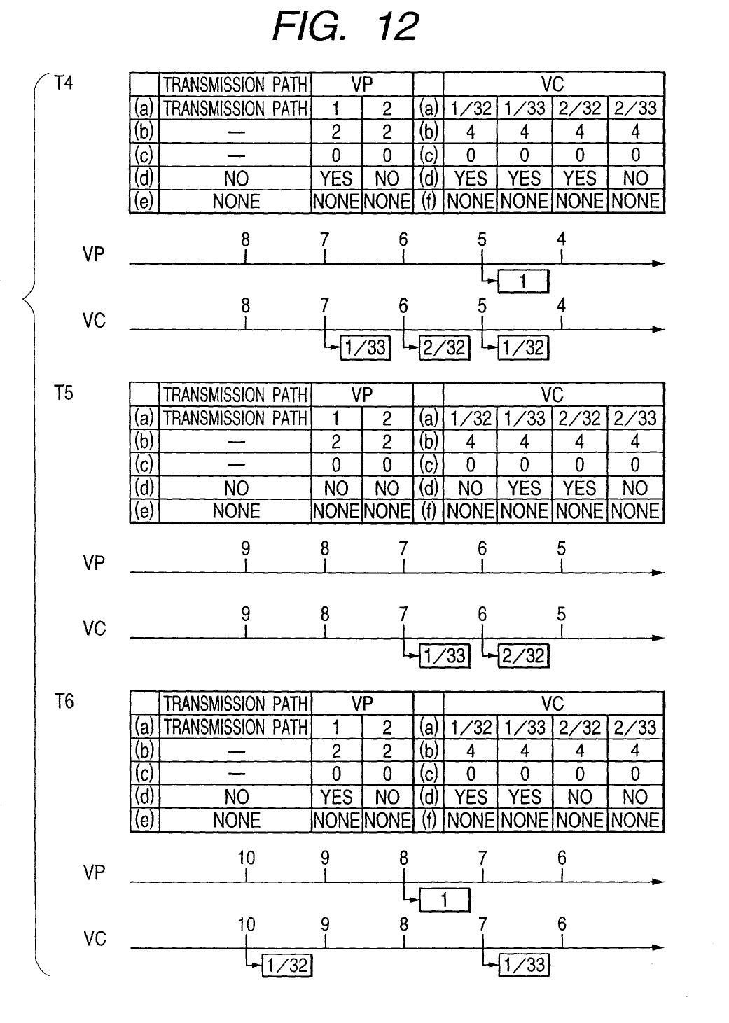

FIGS. 11 through 15 are diagrams illustrating status of the status control table 406 and status of the transmission scheduled-time reservation table 407 at each reference time. Before the shaping is executed, it is assumed that the status control table 406 is in an initial status as shown in FIG. 5, and that the transmission scheduled-time reservation table 407 is in a status which has no registered connection. In this case, for each VP corresponding to VPI=1, 2, a predefined cell transmission interval is 2 and CDVT is 0. For each VC corresponding to VPI/VCI=1/32, 1/33, 2/32, 2/33, a predefined cell transmission interval is 4 and CDVT is 0. In addition, it is also assumed that the priority of connection for transmitting a cell is the following: 1>2 for VP; and 1/32>1/33, 2/32>2/33 for VC.

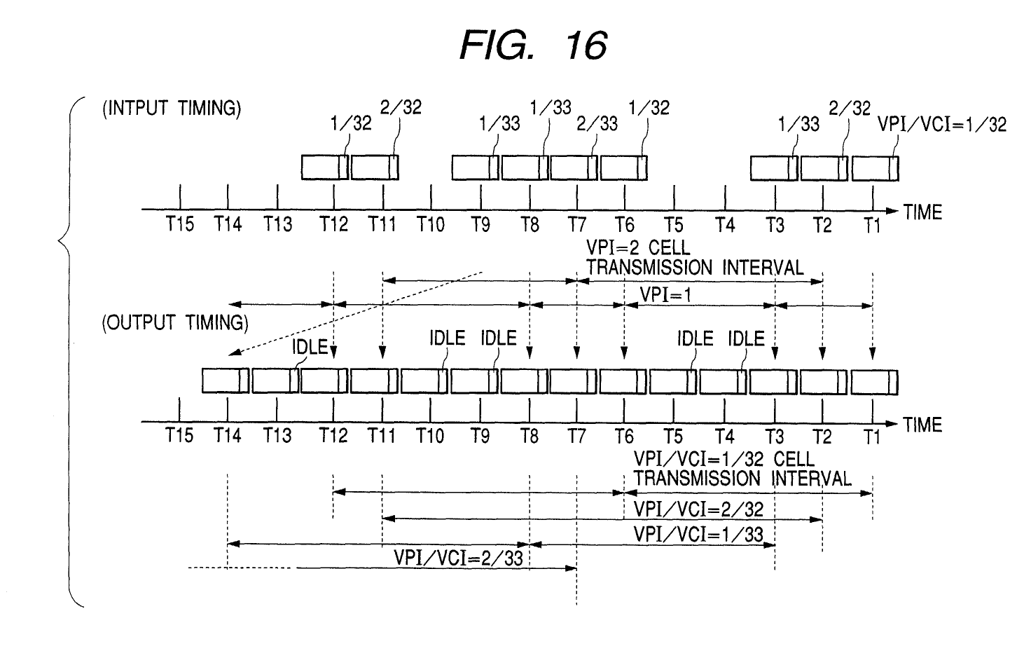

FIG. 16 is a diagram illustrating timing of cell sending/receiving when shaping is executed in the output line interface unit 302-n.

When receiving a cell containing VPI=1, VCI=32 at time T1 (an upper portion of FIG. 16 (time T1)), the processor 403 registers a write address (for example,

0000) for writing the cell into the buffer memory 402 in (f) list of transferable cells of (a) VPI/VCI=1/32 of the status control table 406 (FIG. 8, step S701). Next, the processor 403 judges (d) registration flag of (a) VPI/VCI=1/32 (S702). Because the (d) registration flag of (a) VPI/VCI=1/32 is NO, the processor 403 updates the (d) registration flag of (a) VPI/VCI=1/32 to YES (S703), and registers VPI/VCI=1/32 in (e) list of cell-transferable connections of (a) VPI=1 (S704). After that, the processor 403 judges (d) registration flag of (a) VPI=1 (S705). Because the (d) registration flag of (a) VPI=1 is NO, the processor 403 updates the (d) registration flag of (a) VPI=1 to YES (S706), and registers VPI=1 in (e) list of cell-transferable connections of (a) transmission path (S707). Then, the processor 403 updates the (d) registration flag of the (a) transmission path to YES (S708), and completes the cell receiving process.

In addition, the processor 403 advances a pointer of current time in the transmission scheduled-time reservation table 407 to time T1, and judges whether or not there is a registered VC (FIG. 9A, step S801). Because no VC is registered, the processor 403 judges whether or not there is a registered VP (FIG. 9B, S810). Because no VP is registered, the processor 403 completes the reservation read process.

Next, the processor 403 judges whether or not there is a connection registered in (e) list of cell-transferable connections of (a) transmission path of the status control table 406 (FIG. 10, step S1001). Because a connection of VPI=1 is registered, the processor 403 selects the connection of VPI=1 (S1002), and reads out VPI=1 from the (e) list of cell-transferable connections of (a) transmission path (S1003). Additionally, the processor 403 updates (d) registration flag of the (a) transmission path to NO (S1004). In the next place, the processor 403 determines transmission scheduled time of VPI=1 (T3) according to GCRA, and registers it in the transmission scheduled-time reservation table 407 (S1005).

Next, the processor 403 updates (d) registration flag of (a) VPI=1 of the status control table 406 to YES (S1006). Then, the processor 403 selects a connection of VPI/VCI=1/32 that is registered in (e) list of cell-transferable connections of (a) VPI=1 (S1007). In addition, the processor 403 reads out VPI/VCI=1/32 from the (e) list of cell-transferable connections of (a) VPI=1 (S1008). After that, the processor 403 selects a cell having address 0000 that is registered in (f) list of transferable cells of (a) VPI/VCI=1/32 (S1009), controls the buffer memory 402 to read out the cell, and transmits it to output line (a lower portion of FIG. 16 (time T1)) (S1010). In the next place, the processor 403 determines transmission scheduled time of VPI/VCI=1/32 (T5) according to GCRA, and registers it in the transmission scheduled-time reservation table 407 (S1011). Then, the processor 403 updates (d) registration flag of (a) VPI/VCI=1/32 in the status control table 406 to YES (S1012), and completes the cell transmission process. FIG. 11 shows status of the status control table 406 and status of the transmission scheduled-time reservation table 407 at this time (time T1).

Operation at time T2 when a cell containing VPI=2, VCI=32 is received (the upper portion of FIG. 16 (time T2)) is the same as that at time T1 when a cell containing VPI=1, VCI=32 is received. Transmission scheduled times of VPI=2, VPI/VCI=2/32 are T4, T5 respectively. Timing of cell transmission at this time is shown in the upper portion of FIG. 16 (time T2). In addition, FIG. 11 (time T2) shows status of the status control table 406 and status of the transmission scheduled-time reservation table 407.

When receiving a cell containing VPI=1, VCI=33 at time T3 (the upper portion of FIG. 16 (time T3)), the processor 403 registers a write address (for example, 0004) for writing the cell into the buffer memory 402 in (f) list of transferable cells of (a) VPI/VCI=1/33 of the status control table 406 (S701). Next, the processor 403 judges (d) registration flag of (a) VPI/VCI=1/33 (S702). Because the (d) registration flag of (a) VPI/VCI=1/33 is NO, the processor 403 updates the (d) registration flag to YES (S703). Then, the processor 403 registers VPI/VCI=1/33 in (e) list of cell-transferable connections of (a) VPI=1 (S704). After that, the processor 403 judges (d) registration flag of (a) VPI=1 (S3705). Because the (d) registration flag of (a) VPI=1 is YES, the processor 403 completes the cell receiving process.

In addition, the processor 403 advances a pointer of current time in the transmission scheduled-time reservation table 407 to time T3, and judges whether or not there is a registered VC (S801). Because no VC is registered, the processor 403 then judges whether or not there is a registered VP (S810). Because VPI=1 is registered, the processor 403 reads out VPI=1 from transmission scheduled-time table 506 (S811). Next, the processor 403 judges whether or not there is a connection registered in (e) list of cell-transferable connections of (a) VPI=1 of the status control table 406 (S812). Because a connection of VPI/VCI=1/33 is registered, the processor 403 registers VPI=1 in (e) list of cell-transferable connections of (a) transmission path (S813), updates (d) registration flag of (a) VPI=1 to YES, and then returns to S810. Because no other VP is registered, the processor 403 completes the reservation read process.

Next, the processor 403 judges whether or not there is a connection registered in (e) list of cell-transferable connections of (a) transmission path of the status control table 406 (S1001). Because a connection of VPI=1 is registered, the processor 403 selects the connection of VPI=1 (S1002), and reads out VPI=1 from (e) list of cell-transferable connections of (a) transmission path (S1003). Additionally, the processor 403 updates (d) registration flag of the (a) transmission path to NO (S1004). In the next place, the processor 403 determines transmission scheduled time of VPI=1 (T5) according to GCRA, and registers it in the transmission scheduled-time reservation table 407 (S1005). Next, the processor 403 updates (d) registration flag of (a) VPI=1 of the status control table 406 to YES (S1006). Then, the processor 403 selects a connection of VPI/VCI=1/33 that is registered in (e) list of cell-transferable connections of (a) VPI=1 (S1007). In addition, the processor 403 reads out VPI/VCI=1/33 from (e) list of cell-transferable connections of (a) VPI=1 (S1008). After that, the processor 403 selects a cell having address 0004 that is registered in (f) list of transferable cells of (a) VPI/VCI=1/33 (S1009), controls the buffer memory 402 to read out the cell, and transmits it to output line (the lower portion of FIG. 16 (time T3)) (S1010). In the next place, the processor 403 determines transmission scheduled time of VPI/VCI=1/33 (T7) according to GCRA, and registers it in the transmission scheduled-time reservation table 407 (S1011). Then, the processor 403 updates (d) registration flag of (a) VPI/VCI=1/33 in the status control table 406 to YES (S1012), and completes the cell transmission process. FIG. 11 shows status of the status control table 406 and status of the transmission scheduled-time reservation table 407 at this time (time T3).

Because there is no received cell at time T4 (the upper portion of FIG. 16 (time T4)), the processor 403 does not perform the cell receiving process.

In addition, the processor 403 advances a pointer of current time in the transmission scheduled-time reservation table 407 to time T4, and judges whether or not there is a registered VC (S801). Because no VC is registered, the processor 403 judges whether or not there is a registered VP (S810). Because VPI=2 is registered at time T4, the processor 403 reads out VPI=2 from the transmission scheduled-time table 506 (S811). Next, the processor 403 judges whether or not there is a connection registered in (e) list of cell-transferable connections of (a) VPI=2 of the status control table 406 (S812). Because there is no connection registered in (e) list of cell-transferable connections of (a) VPI=2, the processor 403 updates (d) registration flag of (a) VPI=2 to NO (S815), and then returns to S810. Because no other VP is registered, the processor 403 completes the reservation read process.

Next, the processor 403 judges whether or not there is a connection registered in (e) list of cell-transferable connections of (a) transmission path (S1001). Because there is no registered connection, the processor 403 transmits an idle cell for adjusting cell flow speed to output line (S1013) (the lower portion of FIG. 16 (time T4), and completes the cell transmission process. FIG. 16 shows status of the status control table 406 and status of the transmission scheduled-time reservation table 407 at this time (time T4).

Because there is also no received cell at time T5 (the upper portion of FIG. 16 (time T5)), the processor 403 does not perform the cell receiving process.

In addition, the processor 403 advances a pointer of current time in the transmission scheduled-time reservation table 407 to time T5, and judges whether or not there is a registered VC (S801). Because VPI/VCI=1/32 is registered, the processor 403 reads out VPI/VCI=1/32 from the transmission scheduled-time table 506 (S802). Next, the processor 403 judges whether or not there is a cell registered in (f) list of transferable cells of (a) VPI/VCI=1/32 of the status control table 406 (S803). Because no cell is registered, the processor 403 updates (d) registration flag of (a) VPI/VCI=1/32 to NO (S809) and returns to S801. Because no other VC is registered, the processor 403 judges whether or not there is a registered VP (S810). Because VPI=1 is registered, the processor 403 reads out VPI=1 from the transmission scheduled-time table 506 (S811). Next, the processor 403 judges whether or not there is a connection registered in (e) list of cell-transferable connections of (a) VPI=1 of the status control table 406 (S812). Because no connection is registered, the processor 403 updates (d) registration flag of (a) VPI=1 to NO (S815), and returns to S810. Because no other VP is registered, the processor 403 completes the reservation read process.

Next, the processor 403 judges whether or not there is a connection registered in (e) list of cell-transferable connections of (a) transmission path (S1001). Because there is no registered connection, the processor 403 transmits an idle cell (S1013) (the lower portion of FIG. 16 (time T5)), and completes the cell transmission process. FIG. 16 shows status of the status control table 406 and status of the transmission scheduled-time reservation table 407 at this time (time T5).

When receiving a cell containing VPI=1, VCI=32 at time T6 (the upper portion of FIG. 16 (time T6)), the processor 403 registers a write address (for example, 0006) for writing the cell into the buffer memory 402 in (f) list of transferable cells of (a) VPI/VCI=1/32 of the status control table 406 (S701). Next, the processor 403 judges (d) registration flag of (a) VPI/VCI=1/32 (S702). Because (d) registration flag of (a) VPI/VCI=1/32 is NO, the processor 403 updates the (d) registration flag to YES (S703). Then, the processor 403 registers VPI/VCI=1/32 in (e) list of cell-transferable connections of (a) VPI=1 (S704). After that, the processor 403 judges (d) registration flag of (a) VPI=1 (S705). Because the (d) registration flag of (a) VPI=1 is NO, the processor 403 updates the (d) registration flag to YES (S706). In the next place, the processor 403 registers VPI=1 in (e) list of cell-transferable connections of (a) transmission path (S707). Then, the processor 403 updates (d) registration flag of the (a) transmission path to YES (S708), and completes the cell receiving process.

In addition, the processor 403 advances a pointer of current time in the transmission scheduled-time reservation table 407 to time T6, and judges whether or not there is a registered VC (S801). Because a connection of VPI/VCI=2/32 is registered, the processor 403 reads out VPI/VCI=2/32 from the transmission scheduled-time reservation table 407 (S802). Next, the processor 403 judges whether or not there is a cell registered in (f) list of transferable cells of (a) VPI/VCI=2/32 of the status control table 406 (S803). Because no cell is registered, the processor 403 updates (d) registration flag of (a) VPI/VCI=2/32 to NO (S809), and returns to S801. Because no other VC is registered, the processor 403 judges whether or not there is a registered VP (S810). Because no VP is registered, the processor 403 completes the reservation read process.

Next, the processor 403 judges whether or not there is a connection registered in (e) list of cell-transferable connections of (a) transmission path (S1001). Because a connection of VPI=1 is registered, the processor 403 selects the connection of VPI=1 (S1002) and reads out VPI=1 from the (e) list of cell-transferable connections of the (a) transmission path (S1003). Additionally, the processor 403 updates (d) registration flag of the (a) transmission path to NO (S1004). In the next place, the processor 403 determines transmission scheduled time of VPI=1 (T8) according to GCRA, and registers it in the transmission scheduled-time reservation table 407 (S1005). Next, the processor 403 updates (d) registration flag of (a) VPI=1 of the status control table 406 to YES (S1006). Then, the processor 403 selects a connection of VPI/VCI=1/32 that is registered in (e) list of cell-transferable connections of (a) VPI=1 (S1007). In addition, the processor 403 reads out VPI/VCI=1/32 from the (e) list of cell-transferable connections of (a) VPI=1 (S1008). After that, the processor 403 selects a cell having address 0006 that is registered in (f) list of transferable cells of (a) VPI/VCI=1/32 (S1009), controls the buffer memory 402 to read out the cell, and transmits it to output line (the lower portion of FIG. 16 (time T6)) (S1010). In the next place, the processor 403 determines transmission scheduled time of VPI/VCI=1/32 (T10) according to GCRA, and registers it in the transmission scheduled-time reservation table 407 (S1011). Then, the processor 403 updates (d) registration flag of (a) VPI/VCI=1/32 in the status control table 406 to YES (S1012), and completes the cell transmission process. FIG. 16 shows status of the status control table 406 and status of the transmission scheduled-time reservation table 407 at this time (time T6).

When receiving a cell containing VPI=2, VCI=33 at time T7 (the upper portion of FIG. 16 (time T7)), the processor 403 registers a write address (for example, 0008) for writing the cell into the buffer memory 402 in (f) list of transferable cells of (a) VPI/VCI=2/33 of the status control table 406 (S701). Next, the processor 403 judges (d) registration flag of (a) VPI/VCI=2/33 (S702). Because the (d) registration flag of (a) VPI/VCI=2/33 is NO, the processor 403 updates the (d) registration flag to YES (S703). Then, the processor 403 registers VPI/VCI=2/33 in (e) list of cell-transferable connections of (a) VPI=2 (S704). After that, the processor 403 judges (d) registration flag of (a) VPI=2 (S705). Because (d) registration flag of (a) VPI=1 is NO, the processor 403 updates the (d) registration flag to YES (S706). In the next place, the processor 403 registers VPI=2 in (e) list of cell-transferable connections of (a) transmission path (S707). Then, the processor 403 updates (d) registration flag of the (a) transmission path to YES (S708), and completes the cell receiving process.

In addition, the processor 403 advances a pointer of current time in the transmission scheduled-time reservation table 407 to time T7, and judges whether or not there is a registered VC (S801). Because a connection of VPI/VCI=1/33 is registered, the processor 403 reads out VPI/VCI=1/33 from the transmission scheduled-time reservation table 407 (S802). Next, the processor 403 judges whether or not there is a cell registered in (f) list of transferable cells of (a) VPI/VCI=1/33 of the status control table 406 (S803). Because no cell is registered, the processor 403 updates (d) registration flag of (a) VPI/VCI=1/33 to NO (S809), and returns to S801. Because no other VC is registered, the processor 403 judges whether or not there is a registered VP (S810). Because no VP is registered, the processor 403 completes the reservation read process.

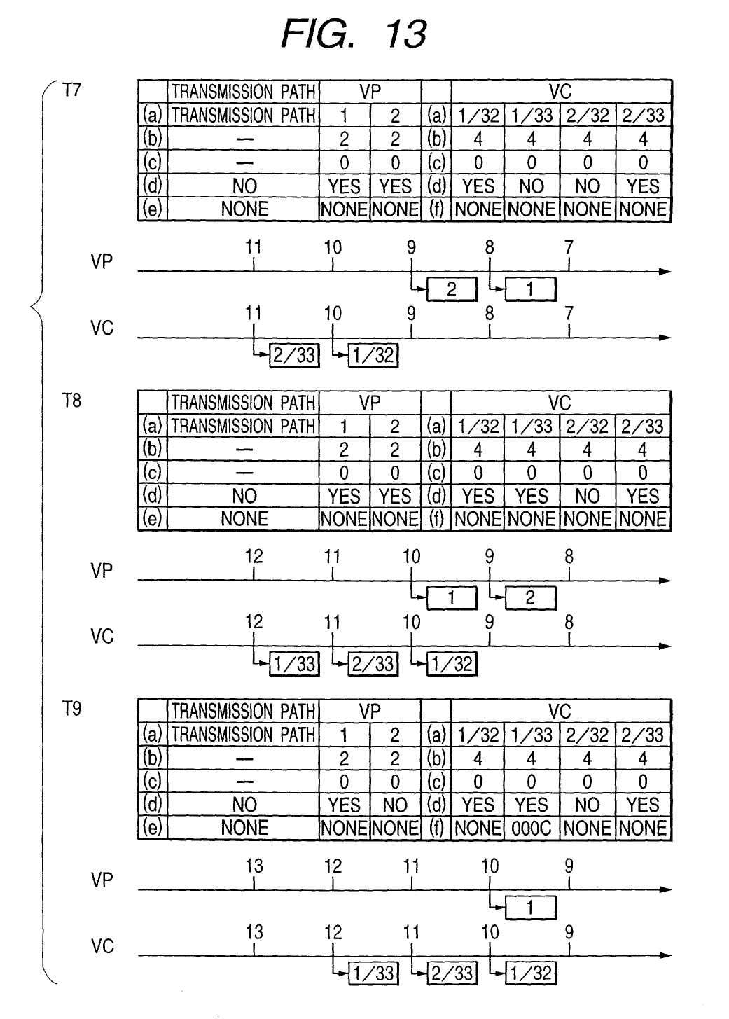

Next, the processor 403 judges whether or not there is a connection registered in (e) list of cell-transferable connections of (a) transmission path (S1001). Because a connection of VPI=2 is registered, the processor 403 selects the connection of VPI=2 (S1002) and reads out VPI=2 from the (e) list of cell-transferable connections of the (a) transmission path (S1003). Additionally, the processor 403 updates (d) registration flag of the (a) transmission path to NO (S1004). In the next place, the processor 403 determines transmission scheduled time of VPI=2 (T9) according to GCRA, and registers it in the transmission scheduled-time reservation table 407 (S1005). Next, the processor 403 updates (d) registration flag of (a) VPI=2 of the status control table 406 to YES (S1006). Then, the processor 403 selects a connection of VPI/VCI=2/33 that is registered in (e) list of cell-transferable connections of (a) VPI=2 (S1007). In addition, the processor 403 reads out VPI/VCI=2/33 from the (e) list of cell-transferable connections of (a) VPI=2 (S1008). After that, the processor 403 selects a cell having address 0008 that is registered in (f) list of transferable cells of (a) VPI/VCI=2/33 (S1009), controls the buffer memory 402 to read out the cell, and transmits it to output line (the lower portion of FIG. 16 (time T7)) (S1010). In the next place, the processor 403 determines transmission scheduled time of VPI/VCI=2/33 (T11) according to GCRA, and registers it in the transmission scheduled-time reservation table 407 (S1011). Then, the processor 403 updates (d) registration flag of (a) VPI/VCI=2/33 in the status control table 406 to YES (S1012), and completes the cell transmission process. FIG. 13 shows status of the status control table 406 and status of the transmission scheduled-time reservation table 407 at this time (time T7).

When receiving a cell containing VPI=1, VCI=33 at time T8 (the upper portion of FIG. 16 (time T8)), the processor 403 registers a write address (for example, 000A) for writing the cell into the buffer memory 402 in (f) list of transferable cells of (a) VPI/VCI=1/33 of the status control table 406 (S701). Next, the processor 403 judges (d) registration flag of (a) VPI/VCI=1/33 (S702). Because the (d) registration flag of (a) VPI/VCI=1/33 is NO, the processor 403 updates the (d) registration flag to YES (S703). Then, the processor 403 registers VPI/VCI=1/33 in (e) list of cell-transferable connections of (a) VPI=1 (S704). After that, the processor 403 judges (d) registration flag of (a) VPI=1 (S705). Because the (d) registration flag of (a) VPI=1 is YES, the processor 403 completes the cell receiving process.

In addition, the processor 403 advances a pointer of current time in the transmission scheduled-time reservation table 407 to time T8, and judges whether or not there is a registered VC (S801). Because no VC is registered, the processor 403 then judges whether or not there is a registered VP (S810). Because VPI=1 is registered, the processor 403 reads out VPI=1 from the transmission scheduled-time table 506 (S811). Next, the processor 403 judges whether or not there is a connection registered in (e) list of cell-transferable connections of (a) VPI=1 of the status control table 406 (S812). Because a connection of VPI=1 is registered, the processor 403 registers VPI=1 in (e) list of cell-transferable connections of (a) transmission path (S813) updates (d) registration flag of (a) VPI=1 to YES, and then returns to S810. Because no other VP is registered, the processor 403 completes the reservation read process.

Next, the processor 403 judges whether or not there is a connection registered in (e) list of cell-transferable connections of (a) transmission path of the status control table 406 (S1001). Because a connection of VPI=1 is registered, the processor 403 selects the connection of VPI=1 (S1002), and reads out VPI=1 from (e) list of cell-transferable connections of (a) transmission path (S1003). Additionally, the processor 403 updates (d) registration flag of the (a) transmission path to NO (S1004). In the next place, the processor 403 determines transmission scheduled time of VPI=1 (T10) according to GCRA, and registers it in the transmission scheduled-time reservation table 407 (S1005). Next, the processor 403 updates (d) registration flag of (a) VPI=1 of the status control table 406 to YES (S1006). Then, the processor 403 selects a connection of VPI/VCI=1/33 that is registered in (e) list of cell-transferable connections of (a) VPI=1 (S1007). In addition, the processor 403 reads out VPI/VCI=1/33 from (e) list of cell-transferable connections of (a) VPI=1 (S1008). After that, the processor 403 selects a cell having address 000A that is registered in (f) list of transferable cells of (a) VPI/VCI=1/33 (S1009), controls the buffer memory 402 to read out the cell, and transmits it to output line (the lower portion of FIG. 16 (time T8)) (S1010). In the next place, the processor 403 determines transmission scheduled time of VPI/VCI=1/33 (T12) according to GCRA, and registers it in the transmission scheduled-time reservation table 407 (S1011). Then, the processor 403 updates (d) registration flag of (a) VPI/VCI=1/33 in the status control table 406 to YES (S1012), and completes the cell transmission process. FIG. 13 shows status of the status control table 406 and status of the transmission scheduled-time reservation table 407 at this time (time T8).

When receiving a cell containing VPI=1, VCI=33 at time T9 (the upper portion of FIG. 16 (time T9)), the processor 403 registers a write address (for example, 000C) for writing the cell into the buffer memory 402 in (f) list of transferable cells of (a) VPI/VCI=1/33 of the status control table 406 (S701). Next, the processor 403 judges (d) registration flag of (a) VPI/VCI=1/33 (S702). Because the (d) registration flag of (a) VPI/VCI=1/33 is YES, the processor 403 completes the cell receiving process.

Moreover, the processor 403 advances a pointer of current time in the transmission scheduled-time reservation table 407 to time T9, and judges whether or not there is a registered VC (S801). Because no VC is registered, the processor 403 then judges whether or not there is a registered VP (S810). Because VPI=2 is registered, the processor 403 reads out VPI=2 from the transmission scheduled-time table 506 (S811). Next, the processor 403 judges whether or not there is a connection registered in (e) list of cell-transferable connections of (a) VPI=2 of the status control table 406 (S812). Because no connection is registered, the processor 403 updates (d) registration flag of (a) VPI=2 to NO (S815), and returns to S810. Because no other VP is registered, the processor 403 completes the reservation read process.

Next, the processor 403 judges whether or not there is a connection registered in (e) list of cell-transferable connections of (a) transmission path (S1001). Because there is no registered connection, the processor 403 transmits an idle cell (S1013) (the lower portion of FIG. 16 (time T9)), and completes the cell transmission process. FIG. 13 shows status of the status control table 406 and status of the transmission scheduled-time reservation table 407 at this time (time T9).

Because there is also no received cell at time T10 (the upper portion of FIG. 16 (time T10)), the processor 403 does not perform the cell receiving process.

In addition, the processor 403 advances a pointer of current time in the transmission scheduled-time reservation table 407 to time T10, and judges whether or not there is a registered VC (S801). Because VPI/VCI=1/32 is registered, the processor 403 reads out VPI/VCI=1/32 from the transmission scheduled-time table 506 (S802). Next, the processor 403 judges whether or not there is a cell registered in (f) list of transferable cells of (a) VPI/VCI=1/32 of the status control table 406 (S803). Because no connection is registered, the processor 403 updates (d) registration flag of (a) VPI/VCI=1/32 to NO (S809), and returns to S801. Because no other VC is registered, the processor 403 judges whether or not there is a registered VP (S810). Because VPI=1 is registered, the processor 403 reads out VPI=1 from the transmission scheduled-time table 506 (S811). Next, the processor 403 judges whether or not there is a connection registered in (e) list of cell-transferable connections of (a) VPI=1 of the status control table 406 (S812). Because no connection is registered, the processor 403 updates (d) registration flag of (a) VPI=1 to NO (S815), and returns to S810. Because no other VP is registered, the processor 403 completes the reservation read process.

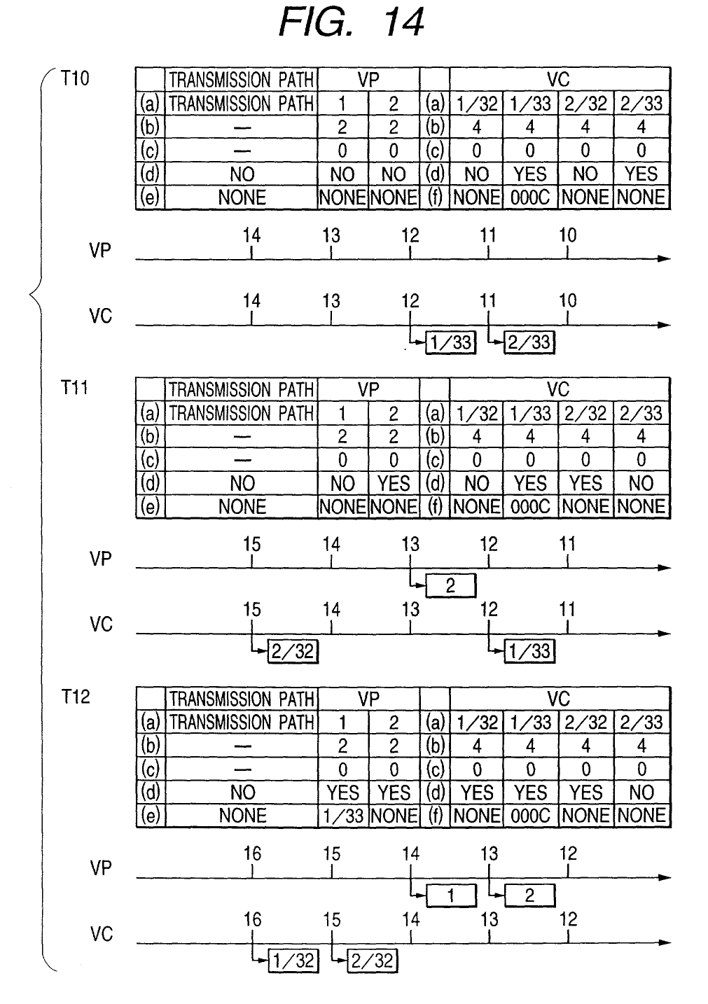

Next, the processor 403 judges whether or not there is a connection registered in (e) list of cell-transferable connections of (a) transmission path (S1001). Because there is no registered connection, the processor 403 transmits an idle cell (S1013) (the lower portion of FIG. 16 (time T10)), and completes the cell transmission process. FIG. 14 shows status of the status control table 406 and status of the transmission scheduled-time reservation table 407 at this time (time T10).

When receiving a cell containing VPI=2, VCI=32 at time T11 (the upper portion of FIG. 16 (time T11)), the processor 403 registers a write address (for example, 000E) for writing the cell into the buffer memory 402 in (f) list of transferable cells of (a) VPI/VCI=2/32 of the status control table 406 (S701). Next, the processor 403 judges (d) registration flag of (a) VPI/VCI=2/32 (S702). Because (d) registration flag of (a) VPI/VCI=2/32 is NO, the processor 403 updates the (d) registration flag to YES (S703). Then, the processor 403 registers VPI/VCI=2/32 in (e) list of cell-transferable connections of (a) VPI=2 (S704). After that, the processor 403 judges (d) registration flag of (a) VPI=2 (S705). Because the (d) registration flag of (a) VPI=2 is NO, the processor 403 updates the (d) registration flag to YES (S706). In the next place, the processor 403 registers VPI=2 in (e) list of cell-transferable connections of (a) transmission path (S707). Then, the processor 403 updates (d) registration flag of the (a) transmission path to YES (S708), and completes the cell receiving process.

In addition, the processor 403 advances a pointer of current time in the transmission scheduled-time reservation table 407 to time T11, and judges whether or not there is a registered VC (S801). Because a connection of VPI/VCI=2/33 is registered, the processor 403 reads out VPI/VCI=2/33 from the transmission scheduled-time reservation table 407 (S802). Next, the processor 403 judges whether or not there is a cell registered in (f) list of transferable cells of (a) VPI/VCI=2/33 of the status control table 406 (S803). Because no cell is registered, the processor 403 updates (d) registration flag of (a) VPI/VCI=2/33 to NO (S809) and returns to S801. Because no other VC is registered, the processor 403 judges whether or not there is a registered VP (S810). Because no VP is registered, the processor 403 completes the reservation read process.

Next, the processor 403 judges whether or not there is a connection registered in (e) list of cell-transferable connections of (a) transmission path (S1001). Because a connection of VPI=2 is registered, the processor 403 selects the connection of VPI=2 (S1002), and reads out VPI=2 from (e) list of cell-transferable connections of (a) transmission path (S1003). Additionally, the processor 403 updates (d) registration flag of the (a) transmission path to NO (S1004). In the next place, the processor 403 determines transmission scheduled time of VPI=1 (T13) according to GCRA, and registers it in the transmission scheduled-time reservation table 407 (S1005). Next, the processor 403 updates (d) registration flag of (a) VPI=2 of the status control table 406 to YES (S1006). Then, the processor 403 selects a connection of VPI/VCI=2/32 that is registered in (e) list of cell-transferable connections of (a) VPI=2 (S1007). In addition, the processor 403 reads out VPI/VCI=2/32 from (e) list of cell-transferable connections of (a) VPI=2 (S1008). After that, the processor 403 selects a cell having address 000E that is registered in (f) list of transferable cells of (a) VPI/VCI=2/32 (S1009), controls the buffer memory 402 to read out the cell, and transmits it to output line (the lower portion of FIG. 16 (time T11)) (S1010). In the next place, the processor 403 determines transmission scheduled time of VPI/VCI=2/32 (T15) according to GCRA, and registers it in the transmission scheduled-time reservation table 407 (S1011). The processor 403 updates (d) registration flag of (a) VPI/VCI=2/32 in the status control table 406 to YES (S1012), and completes the cell transmission process. FIG. 14 shows status of the status control table 406 and status of the transmission scheduled-time reservation table 407 at this time (time T11). When receiving a cell containing VPI=1, VCI=32 at time T12 (the upper portion of FIG. 16 (time T12)), the processor 403 registers a write address (for example, 0010) for writing the into the buffer memory 402 in (f) list of transferable cells of (a) VPI/VCI=1/32 of the status control table 406 (S701). Next, the processor 403 judges (d) registration flag of (a) VPI/VCI=1/32 (S702). Because the (d) registration flag of (a) VPI/VCI=1/32 is NO, the processor 403 updates the (d) registration flag to YES (S703). Then, the processor 403 registers VPI/VCI=1/32 in (e) list of cell-transferable connections of (a) VPI=1 (S704). After that, the processor 403 judges (d) registration flag of (a) VPI=1 (S705). Because the (d) registration flag of (a) VPI=1 is NO, the processor 403 updates the (d) registration flag to YES (S706). In the next place, the processor 403 registers VPI=1 in (e) list of cell-transferable connections of (a) transmission path (S707). Then, the processor 403 updates (d) registration flag of the (a) transmission path to YES (S708), and completes the cell receiving process.

In addition, the processor 403 advances a pointer of current time in the transmission scheduled-time reservation table 407 to time T12, and judges whether or not there is a registered VC (S801). Because a connection of VPI/VCI=1/33 is registered, the processor 403 reads out VPI/VCI=1/33 from the transmission scheduled-time reservation table 407 (S802). Next, the processor 403 judges whether or not there is a cell registered in (f) list of transferable cells of (a) VPI/VCI=1/33 of the status control table 406 (S803). Because there is a registered cell, the processor 403 registers VPI/VCI=1/33 in (e) list of cell-transferable connections of (a) VPI=1 (S704). After that, the processor 403 judges (d) registration flag of (a) VPI=1 (S805). Because the (d) registration flag of (a) VPI=1 is YES, the processor 403 returns to S801. Because no other VC is registered, the processor 403 judges whether or not there is a registered VP (S810). Because no VP is registered, the processor 403 completes the reservation read process.

Next, the processor 403 judges whether or not there is a connection registered in (e) list of cell-transferable connections of (a) transmission path (S1001). Because a connection of VPI=1 is registered, the processor 403 selects the connection of VPI=1 (S1002), and reads out VPI=1 from (e) list of cell-transferable connections of (a) transmission path (S1003). Additionally, the processor 403 updates (d) registration flag of the (a) transmission path to NO (S1004). In the next place, the processor 403 determines transmission scheduled time of VPI=1 (T14) according to GCRA, and registers it in the transmission scheduled-time reservation table 407 (S1005). Next, the processor 403 updates (d) registration flag of (a) VPI=1 of the status control table 406 to YES (S1006). Then, the processor 403 selects VPI/VCI=1/32 from among VPI/VCI=1/32, 1/33, which are registered in (e) list of cell-transferable connections of (a) VPI=1, according to a predefined priority (S1007). Next, the processor 403 reads out VPI/VCI=1/32 from (e) list of cell-transferable connections of (a) VPI=1 (S1008). After that, the processor 403 selects a cell having address 0010 that is registered in (f) list of transferable cells of (a) VPI/VCI=1/32 (S1009), controls the buffer memory 402 to read out the cell, and transmits it to output line (the lower portion of FIG. 16 (time T12)) (S1010). In the next place, the processor 403 determines transmission scheduled time of VPI/VCI=1/32 (T16) according to GCRA, and registers it in the transmission scheduled-time reservation table 407 (S1011). Then, the processor 403 updates (d) registration flag of (a) VPI/VCI=1/32 in the status control table 406 to YES (S1012), and completes the cell transmission process. FIG. 14 shows status of the status control table 406 and status of the transmission scheduled-time reservation table 407 at this time (time T12).

Because there is no received cell at time T13 (the upper portion of FIG. 16 (time T13)), the processor 403 does not perform the cell receiving process. In addition, the processor 403 advances a pointer of current time in the transmission scheduled-time reservation table 407 to time T13, and judges whether or not there is a registered VC (S801). Because no VC is registered, the processor 403 judges whether or not there is a registered VP (S810). Because VPI=2 is registered, the processor 403 reads out VPI=2 from the transmission scheduled-time table 506 (S811). Next, the processor 403 judges whether or not there is a connection registered in (e) list of cell-transferable connections of (a) VPI=2 of the status control table 406 (S812). Because no connection is registered, the processor 403 updates (d) registration flag of (a) VPI=2 to NO (S815), and returns to S810. Because no other VP is registered, the processor 403 completes the reservation read process.

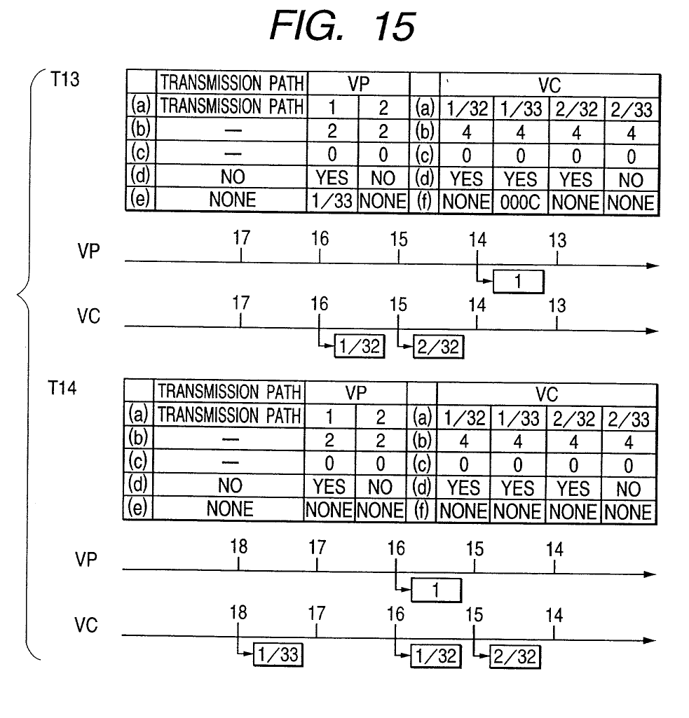

Next, the processor 403 judges whether or not there is a connection registered in (e) list of cell-transferable connections of (a) transmission path (S1001). Because there is no registered connection, the processor 403 transmits an idle cell (S1013) (the lower portion of FIG. 16 (time T13)), and completes the cell transmission process. FIG. 15 shows status of the status control table 406 and status of the transmission scheduled-time reservation table 407 at this time (time T13).

Because there is no received cell at time T14 (the upper portion of FIG. 16 (time T14)), the processor 403 does not perform the cell receiving process.

In addition, the processor 403 advances a pointer of current time in the transmission scheduled-time reservation table 407 to time T14, and judges whether or not there is a registered VC (S801). Because no VC is registered, the processor 403 then judges whether or not there is a registered VP (S810). Because VPI=1 is registered, the processor 403 reads out VPI=1 from the transmission scheduled-time table 506 (S811). Next, the processor 403 judges whether or not there is a connection registered in (e) list of cell-transferable connections of (a) VPI=1 of the status control table 406 (S812). Because VPI/VCI=1/33 is registered, the processor 403 registers VPI=1 in (e) list of cell-transferable connections of (a) transmission path (S813). Then, the processor 403 updates (d) registration flag of the (a) transmission path to YES (S814), and returns to S810. Because no other VP is registered, the processor 403 completes the reservation read process.

Next, the processor 403 judges whether or not there is a connection registered in (e) list of cell-transferable connections of (a) transmission path (S1001). Because a connection of VPI=1 is registered, the processor 403 selects the connection of VPI=1 (S1002) and reads out VPI=1 from (e) list of cell-transferable connections of (a) transmission path (S1003). Additionally, the processor 403 updates (d) registration flag of the (a) transmission path to NO (S1004). In the next place, the processor 403 determines transmission scheduled time of VPI=1 (T16) according to GCRA, and registers it in the transmission scheduled-time reservation table 407 (S1005). Next, the processor 403 updates (d) registration flag of (a) VPI=1 of the status control table 406 to YES (S1006). Then, the processor 403 selects VPI/VCI=1/33 that is registered in (e) list of cell-transferable connections of (a) VPI=1 (S1007). Next, the processor 403 reads out VPI/VCI=1/33 from (e) list of cell-transferable connections of (a) VPI=1 (S1008). After that, the processor 403 selects a cell having address 000C that is registered in (f) list of transferable cells of (a) VPI/VCI=1/33 (S1009), controls the buffer memory 402 to read out the cell, and transmits it to output line (the lower portion of FIG. 16 (time T14)) (S1010). In the next place, the processor 403 determines transmission scheduled time of VPI/VCI=1/33 (T18) according to GCRA, and registers it in the transmission scheduled-time reservation table 407 (S1011). Then, the processor 403 updates (d) registration flag of (a) VPI/VCI=1/33 in the status control table 406 to YES (S1012), and completes the cell transmission process. FIG. 15 shows status of the status control table 406 and status of the transmission scheduled-time reservation table 407 at this time (time T14).

Shaping operation described above realizes shaping that satisfies the following: for VPI=1, a predefined cell transmission interval (2) of VPI=1, and CDVT (0); and for VPI=2, a predefined cell transmission interval (2) of VPI=2, and CDVT (0). In addition, the shaping also satisfies the following: for VPI/VCI=1/32, a predefined cell transmission interval (4) of VPI/VCI=1/32, and CDVT (0); for VPI/VCI=1/33, a predefined cell transmission interval (4) of VPI/VCI=1/33, and CDVT (0); for VPI/VCI=2/32, a predefined cell transmission interval (4) of VPI/VCI=2/32, and CDVT (0); and for VPI/VCI=2/33, a predefined cell transmission interval (4) of VPI/VCI=2/33, and CDVT (0). Moreover, because a transmission band is not dedicated to a particular VP or VC, the transmission band can be utilized efficiently.

As evident from the embodiments described above, according to the present invention, it is possible to provide a communication apparatus having a shaping function, which controls a cell transmission interval so that the cell transmission interval is kept constant for each of VP and VC that are set on a transmission path.

In addition, according to the present invention, it is possible to provide a communication apparatus having a shaping function, which ensures CDVT.

Moreover, according to the present invention, it is possible to provide a communication apparatus having a shaping function, which enables us to utilize a transmission band effectively.

What is claimed is:

1. A communication apparatus having a plurality of input and output ports for handling a fixed-length packet,
wherein for each of a first and a second connections identified by an identifier of said fixed-length packet from said input port, a time interval, during which said fixed-length packet is output, is controlled so that the time interval becomes equal to or longer than a given interval.

2. A communication apparatus according to claim 1, wherein during the time when a fixed-length packet having a first value as an identifier of said first connection is required to be transmitted to said output port, a fixed-length packet having a second value as an identifier of said first connection can be transmitted to an output port according to predetermined rules.

3. A communication apparatus according to claim 1, wherein during the time when a fixed-length packet having a first value as an identifier of said second connection is required to be transmitted to said output port, a fixed-length packet having a second value as an identifier of said second connection can be transmitted to an output port according to predetermined rules.

4. A communication apparatus having a plurality of input and output ports for handling a fixed-length packet, said communication apparatus comprising:
a first means for accumulating said fixed-length packet from said input port;
a second means for identifying a first and a second connections by an identifier of said fixed-length packet from said input port; and
a third means for controlling a time interval, during which said fixed-length packet accumulated in said first means is read, so that the time interval becomes equal to or longer than a given interval, for each of said first connection and said second connection.

5. A communication apparatus according to claim 4, wherein said third means controls a time interval, during which said fixed-length packet accumulated in said first means is read, using a transmission interval and a delay variation value that have been predefined for said fixed-length packet.

6. A communication apparatus according to claim 4, wherein said third means controls a time interval so that, during the time when a fixed-length packet having a first value as an identifier of said first connection is required to be transmitted to said output port, a fixed-length packet having a second value as an identifier of said first connection can be transmitted to an output port according to predetermined rules.

7. A communication apparatus according to claim 4, wherein said third means controls a time interval so that, during the time when a fixed-length packet having a first value as an identifier of said second connection is required to be transmitted to said output port, a fixed-length packet having a second value as an identifier of said second connection can be transmitted to an output port according to predetermined rules.

8. A communication apparatus having a plurality of input and output ports for handling a fixed-length packet, comprising:
a controller for determining transmission scheduled time of each of said fixed-length packets according to predetermined rules for a connection identified by an identifier of the fixed-length packet from said input port.

9. A communication apparatus according to claim 8, wherein said controller determines said transmission scheduled time, using a transmission interval and a delay variation value that have been predefined for said fixed-length packet.

10. A communication apparatus according to claim 8, wherein said controller selects a first connection when the transmission scheduled time has come; and said controller selects a second connection if there is no fixed-length packet to be transmitted for said first connection.
